(19) United States
(12) Patent Application Publication
(10) Pub. No.: US 2019/0319896 A1
(43) Pub. Date: Oct. 17, 2019

(54) Packet Forwarding Method And Physical Host

(71) Applicant: HUAWEI TECHNOLOGIES CO., LTD., Shenzhen (CN)

(72) Inventors: Feng GUO, Shenzhen (CN); Haifeng LIN, Hangzhou (CN); Haibo ZHANG, Hangzhou (CN)

(21) Appl. No.: 16/453,346

(22) Filed: Jun. 26, 2019

Related U.S. Application Data
(63) Continuation of application No. PCT/CN2017/105823, filed on Oct. 12, 2017.

(30) Foreign Application Priority Data
Dec. 27, 2016 (CN) 201611228028.6

(51) Int. Cl. H04L 12/947; H04L 12/931; G06F 9/455

(52) U.S. Cl. CPC H04L 49/252; H04L 49/70; G06F 2009/45583; G06F 2009/45595; G06F 9/45558

(57) ABSTRACT

Embodiments of the present disclosure provide a packet forwarding method and a physical host. The physical host includes a first virtual switch and at least two virtual machines, each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines.

### CROSS-REFERENCE TO RELATED APPLICATIONS

This application is a continuation of International Application No. PCT/CN2017/105823, filed on Oct. 12, 2017, which claims priority to China Patent 201611228028.6, filed on Dec. 27, 2016. The disclosures of the aforementioned applications are hereby incorporated by reference in their entireties.

### TECHNICAL FIELD

Embodiments of the present disclosure relate to the communications field, and more specifically, to a packet forwarding method and a physical host.

### BACKGROUND

Network Functions Virtualization (Network Functions Virtualization, NFV), proposed by a telecommunication network operator, is a technical standard that uses a virtualization technology of an information technology (Information Technology, IT) and an industry-standard large-capacity server, memory, and switch to carry various network software functions.

A plurality of virtual machines (Virtual machine, VM) may run simultaneously on a physical server by using the virtualization technology. These VMs need to share a physical network interface card to communicate with an external resource. In addition, the VMs need to communicate with each other. Therefore, a virtual switch (Virtual switch, vSswtich) is added to a virtual machine monitor (Virtual Machine Monitor, VMM) to resolve the foregoing problem. To improve performance of the Vswtich, a user mode Vswtich is introduced in the industry, and a Data Plane Development Kit (Data Plane Development Kit, DPDK) is used to receive/transmit a network packet from/to the physical network interface card.

In the prior art, an Ivshmem solution may enable a host machine (Host) and all VMs to share a same memory storage area by configuring a virtual operating system emulator (QEMU) command. Because the host and the VM on the host share memory, a memory pool (mbufpool) may be established in the shared memory area. The memory pool may have a plurality of memory blocks (mbuf). Both the VM and a physical network interface card of the host may use the memory block of the shared memory area to receive and transmit a packet. Because the mbuf exists in the shared memory area, the host may directly transmit a network packet received by the physical network interface card to the VM, without copying content of the network packet.

However, when the host shares the memory to all the VMs, the host and all the VMs can read and write the shared memory area, and mbuf information established in the shared memory can be rewritten by all the virtual machines. This may cause a disastrous consequence for a system. Consequently, system reliability is reduced.

### SUMMARY

Embodiments of the present disclosure provide a packet forwarding method and a physical host, so as to improve system reliability.

According to a first aspect, a packet forwarding method is provided. The method is applied to a physical host, and the physical host includes:
a first virtual switch and at least two virtual machines; each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines; and
the method includes:
obtaining, by the first virtual switch, a first memory block that stores a first packet, where the first memory block carries an index field that is used to identify a virtual machine to which the first memory block belongs; and
forwarding, by the first virtual switch, the first packet according to the index field of the first memory block.

The physical host separately establishes shared memory areas with the at least two virtual machines, and the shared memory areas are isolated from each other. This eliminates a possibility that a network packet stored in the shared memory area is modified by another virtual machine, so that system reliability can be improved.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

In a possible design, the memory block in each first memory pool includes a first memory segment and a second memory segment, the first memory segment is in front of the second memory segment, the first memory segment is configured to store address information of the second memory segment, and the second memory segment is configured to store a packet; the physical host has at least two second memory pools, each second memory pool in the at least two second memory pools is in a one-to-one correspondence with each first memory pool, and each second memory pool has a first memory segment in a corresponding first memory pool; and
the forwarding, by the first virtual switch, the first packet according to the index field of the first memory block includes:
forwarding, by the first virtual switch, the first packet according to the at least two second memory pools and the index field of the first memory block.

A memory block in the second memory pool includes only a head of the memory block. Therefore, the virtual machine may use a head in the shared memory area to operate the memory block, and the physical host may use the head in the second memory pool to operate the memory block. This resolves a problem that a system exception occurs on the physical host when the physical host operates the memory block because the virtual machine modifies the head of the memory block, so that system reliability is further improved.

In a possible design, the physical host has a physical network interface card receive queue according to the at least two second memory pools, the first virtual machine has a send queue and/or a receive queue, and the receive queue or the send queue of the first virtual machine includes some or all memory blocks in a first memory pool of the first virtual machine; and
the obtaining, by the first virtual switch, a first memory block that stores a first packet includes:
obtaining, by the first virtual switch, the first memory block in the physical network interface card receive queue; or obtaining, by the first virtual switch, the first memory block in the send queue of the first virtual machine.

In a possible design, the first virtual switch is configured to forward a packet to the first virtual machine; and the forwarding, by the first virtual switch, the first packet according to the at least two second memory pools and the index field of the first memory block includes:
if a virtual machine identified by the index field of the first memory block is the first virtual machine, scheduling, by the first virtual switch, a memory block from the first memory pool of the first virtual machine as a second memory block; assigning, by the first virtual switch, address information of the first memory block to the second memory block; and filling, by the first virtual switch, the second memory block into the receive queue of the first virtual machine.

In a possible design, the first virtual switch is configured to forward a packet to the first virtual machine; and the forwarding, by the first virtual switch, the first packet according to the at least two second memory pools and the index field of the first memory block includes:
if a virtual machine identified by the index field of the first memory block is not the first virtual machine, scheduling, by the first virtual switch, a memory block from the at least two second memory pools as a third memory block, where a virtual machine identified by an index field of the third memory block is the first virtual machine; copying, by the first virtual switch, content of the first memory block to the third memory block; scheduling, by the first virtual switch, a memory block from the first memory pool of the first virtual machine as the second memory block; assigning, by the first virtual switch, address information of the third memory block to the second memory block; and filling, by the first virtual switch, the second memory block into the receive queue of the first virtual machine.

The memory block for forwarding the packet is extracted from the second memory pool, and a data area of the second memory pool is not shared and includes head information. This can effectively prevent the head information of the memory block from being damaged by the virtual machine in a packet forwarding process, so as to improve system reliability.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

In a possible design, the first virtual switch is configured to forward the first packet to the physical network interface card receive queue; and the forwarding, by the first virtual switch, the first packet according to the at least two second memory pools and the index field of the first memory block includes:
obtaining, by the first virtual switch, a fourth memory block from the at least two second memory pools, where a virtual machine identified by an index field of the fourth memory block is the first virtual machine; assigning, by the first virtual switch, address information of the first memory block to the fourth memory block; and filling, by the first virtual switch, the fourth memory block into the physical network interface card receive queue.

The memory block for forwarding the packet is extracted from the second memory pool, and a data area of the second memory pool is not shared and includes head information. This can effectively prevent the head information of the memory block from being damaged by the virtual machine in a packet forwarding process, so as to improve system reliability.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

According to a second aspect, an embodiment of the present disclosure provides a physical host. The physical host includes:
a first virtual switch and at least two virtual machines; each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines; and
the first virtual switch is configured to obtain a first memory block that stores a first packet, where the first memory block carries an index field that is used to identify a virtual machine to which the first memory block belongs; and the first virtual switch is further configured to forward the first packet according to the index field of the first memory block.

In a possible design, the memory block in each first memory pool includes a first memory segment and a second memory segment, the first memory segment is in front of the second memory segment, the first memory segment is configured to store address information of the second memory segment, and the second memory segment is configured to store a packet; the physical host has at least two second memory pools, each second memory pool in the at least two second memory pools is in a one-to-one correspondence with each first memory pool, and each second memory pool has a first memory segment in a corresponding first memory pool; and
the first virtual switch is specifically configured to forward the first packet according to the at least two second memory pools and the index field of the first memory block.

In a possible design, the physical host has a physical network interface card receive queue according to the at least two second memory pools, the first virtual machine has a send queue and/or a receive queue, and the receive queue or the send queue of the first virtual machine includes some or all memory blocks in a first memory pool of the first virtual machine; and
the first virtual switch is specifically configured to obtain the first memory block in the physical network interface card receive queue, or the first virtual switch is specifically configured to obtain the first memory block in the send queue of the first virtual machine.

In a possible design, the first virtual switch is configured to forward a packet to the first virtual machine, where if a virtual machine identified by the index field of the first memory block is the first virtual machine, the first virtual switch schedules a memory block from the first memory pool of the first virtual machine as a second memory block; the first virtual switch is configured to assign address information of the first memory block to the second memory block; and the first virtual switch is configured to fill the second memory block into the receive queue of the first virtual machine.

In a possible design, the first virtual switch is configured to forward a packet to the first virtual machine, where if a virtual machine identified by the index field of the first memory block is not the first virtual machine, the first virtual switch schedules a memory block from the at least two second memory pools as a third memory block, where a virtual machine identified by an index field of the third memory block is the first virtual machine; the first virtual switch is configured to copy content of the first memory block to the third memory block; the first virtual switch is configured to schedule a memory block from the first memory pool of the first virtual machine as the second memory block; the first virtual switch is configured to assign address information of the third memory block to the second memory block; and the first virtual switch is configured to fill the second memory block into the receive queue of the first virtual machine.

In a possible design, the first virtual switch is configured to forward the first packet to the physical network interface card receive queue, where the first virtual switch is configured to obtain a fourth memory block from the at least two second memory pools, and a virtual machine identified by an index field of the fourth memory block is the first virtual machine; the first virtual switch is configured to assign address information of the first memory block to the fourth memory block; and the first virtual switch is configured to fill the fourth memory block into the physical network interface card receive queue.

According to a third aspect, a physical host is provided, and the physical host provided in this embodiment of the present disclosure includes an input device, an output device, a processor, and a memory, where the processor, the memory, and an interface communicate with each other and transmit a control and/or a data signal by using an internal connection channel.

The processor simulates, on the physical host, a first virtual switch and at least two virtual machines by invoking virtual machine software stored in the memory. Each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines; and the first virtual switch is configured to:
obtain a first memory block that stores a first packet, where the first memory block carries an index field that is used to identify a virtual machine to which the first memory block belongs; and forward the first packet according to the index field of the first memory block.

With reference to the foregoing aspects, in a possible design, the address information includes information about a data length field and information about a data starting position offset field.

With reference to the foregoing aspects, in a possible design, the physical host has a physical network interface card memory block queue, and the method further includes: filling, by the physical host, the physical network interface card memory block queue according to a memory block in the at least two second memory pools.

With reference to the foregoing aspects, in a possible design, before the filling, by the physical host, the physical network interface card memory block queue according to a memory block in the at least two second memory pools, the method further includes:
obtaining, by the physical host, traffic statistics information of each virtual machine in the at least two virtual machines; and determining, by the physical host according to the traffic statistics information, a traffic ratio between traffic of each virtual machine in the at least two virtual machines and total traffic of the at least two virtual machines; and the filling, by the physical host, the physical network interface card memory block queue according to a memory block in the at least two second memory pools includes: determining, by the physical host, a traffic ratio of the first virtual machine as a ratio between a quantity of memory blocks corresponding to the first virtual machine filled in the physical network interface card memory block queue and a total quantity of memory blocks filled in the physical network interface card memory block queue.

According to the physical network interface card memory block queue in this embodiment of the present disclosure, network traffic that enters each virtual machine is monitored, and the ratio between memory blocks that are from the second memory pools and in the physical network interface card memory block queue is dynamically adjusted, so as to resolve a problem of a low matching probability between a memory block that stores a packet and a memory block of a destination virtual machine.

With reference to the foregoing aspects, in a possible design, the physical host generates the first shared memory area by configuring a metadata file for the first virtual machine, and the metadata file includes port information of the first virtual machine and the memory block in the first memory pool of the first virtual machine.

The metadata file includes the port information of the first virtual machine, but does not include port information of another virtual machine. This can effectively prevent the virtual port from damaging important information of another virtual port.

In addition, the metadata file includes the memory block of the first memory pool of the first virtual machine, but does not include a head of the first memory pool of the first virtual machine. This can prevent head management information of the first memory pool from being damaged by a virtual machine, so as to further improve system reliability.

With reference to the foregoing aspects, in a possible design, according to the traffic ratio between the at least two virtual machines, the physical host may further apply for a corresponding quantity of memory blocks from each second memory pool, and put the memory blocks into the physical network interface card memory block queue.

### BRIEF DESCRIPTION OF DRAWINGS

FIG. 1 is a schematic block diagram of a virtual machine architecture according to an embodiment of the present disclosure;

FIG. 2 is a schematic structural diagram of a memory block according to an embodiment of the present disclosure;

FIG. 3 is a schematic block diagram of a principle of a packet forwarding apparatus in the prior art;

FIG. 4 is a schematic block diagram of an internal structure of a physical host for forwarding a packet according to an embodiment of the present disclosure;

FIG. 5 is a schematic structural block diagram of a second memory pool corresponding to a first shared memory area according to an embodiment of the present disclosure;

FIG. 6 is a schematic structural diagram of a physical network interface card receive queue according to an embodiment of the present disclosure;

FIG. 7 is a schematic structural block diagram of a shared memory area and a second memory pool according to an embodiment of the present disclosure;

FIG. 8 is a schematic flowchart of a method for forwarding a packet to a first virtual machine by a first virtual switch according to an embodiment of the present disclosure;

FIG. 9 is a schematic flowchart of a method for forwarding a packet to a physical network interface card receive queue by a first virtual switch according to an embodiment of the present disclosure; and

FIG. 10 is a schematic block diagram of a physical host according to an embodiment of the present disclosure.

### DESCRIPTION OF EMBODIMENTS

A method and a physical host that are provided in the embodiments of the present disclosure may be applied to a virtual machine architecture including a plurality of operating systems. For example, the method and the physical host may be applied to a virtual machine architecture including one or more operating systems of Linux, Windows, Unix, or the like. The virtual machine architecture may further include other operating systems, and this is not limited in the embodiments of the present disclosure.

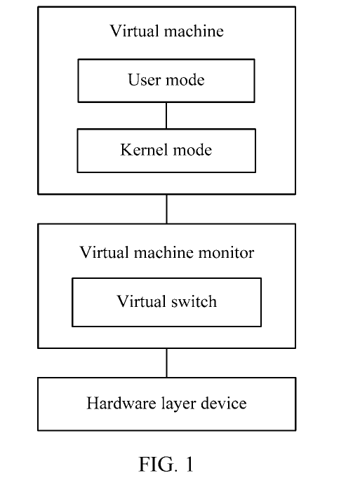

For ease of understanding, with reference to FIG. 1 to FIG. 3, an architecture of a communications system applicable to a packet forwarding method according to an embodiment of the present disclosure and a function of each device in the communications system are first described.

FIG. 1 is a schematic block diagram of a virtual machine architecture according to an embodiment of the present disclosure.

As shown in FIG. 1, a virtual machine includes a user mode and a kernel mode, which are two operating levels of an operating system. A user delivers various instructions in the user mode, and the instructions delivered by the user are generated in the user mode of the virtual machine and delivered to the kernel mode of the virtual machine.

A virtual machine monitor (Virtual Machine Monitor, VMM) is communicatively connected to the virtual machine. The VMM may also be referred to as a Hypervisor, and is configured to manage the foregoing one or more virtual machines. The VMM in this embodiment of the present disclosure is an intermediate software layer running between a physical server and an operating system, and the VMM may allow a plurality of operating systems and applications to share one set of basic physical hardware. Therefore, the VMM may also be considered as a “meta” operating system in a virtual circumstance, and the VMM may coordinate accesses to all hardware layer devices and virtual machines on a server. A basic function of the VMM is uninterruptedly supporting migration of multiple workloads. When the server is started and runs the VMM, the server allocates a proper quantity of memory, CPUs, networks, and disks to each virtual machine, and loads guest operating systems of all the virtual machines.

Related functions of memory allocation in the C language mainly include alloc, calloc, malloc, free, realloc, sbrk, and the like. Memory applied for by using alloc does not need to be released.

It should be understood that the virtual machine architecture (or system) may include one or more virtual machines. These virtual machines need to share a physical network interface card to communicate with an external resource. In addition, the virtual machines need to communicate with each other. Therefore, a virtual switch may be added to the Hypervisor to resolve the foregoing problem. To further improve performance of the virtual switch, a user mode virtual switch (Vswtich) is introduced in the industry, and application software based on a Data Plane Development Kit (Data Plane Development Kit, DPDK) receives/transmits a network packet from/to an mbuf of the physical network interface card according to a data structure of the mbuf.

It should be noted that in a virtual switching environment, the physical network interface card is held by a host machine (Host), and the virtual machine needs to use the physical network interface card to perform external network interaction by using the host. However, in a virtualization environment, memory space of one virtual machine is isolated from memory space of another virtual machine, and memory space of the virtual machines is isolated from memory space of the host. Therefore, a network packet needs to be transferred between the virtual machine and the host by using a special means.

The physical network interface card is also referred to as a network adapter (also as Network Interface Card, NIC).

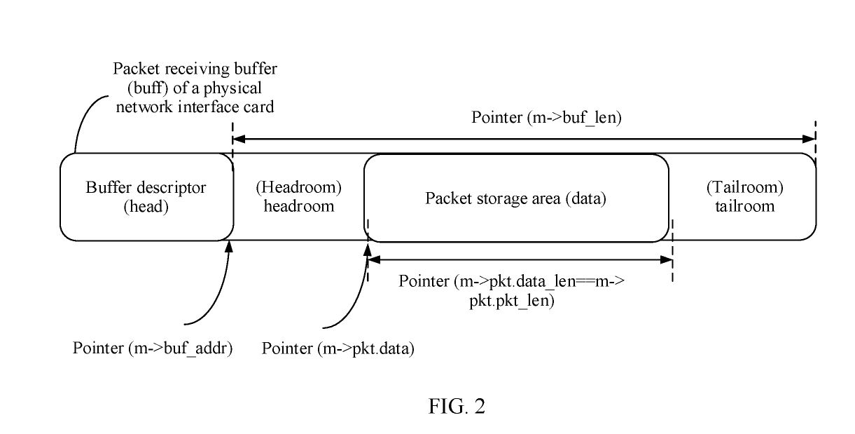

FIG. 2 shows a schematic structural diagram of a memory block according to an embodiment of the present disclosure.

As shown in FIG. 2, a data structure of the mbuf is divided into a first memory segment, configured to store address information of a second memory segment that is in the memory block and that is configured to store a packet. The first memory segment may also be referred to as a head (head) of the memory block, and the second memory segment may also be referred to as a packet storage part (data). The address information in the head may indicate an mbuf address of the packet by using an m->buf_addr instruction, indicate an mbuf length of the packet by using m->buf_len, point to a storage area of the packet by using a pointer m->pkt.data, and indicate an actual length of the packet by using m->pkt.data_len==m->pkt.pkt_len. Headroom (headroom) and tailroom (tailroom) are separately reserved before and after the second memory segment, so as to facilitate an application in decapsulating the packet.

It should be understood that the mbuf is managed by a memory pool (rte_mempool), and the rte_mempool applies for a plurality of mbufs at one time during initialization. A quantity and a length of applied mbufs may be specified by a user. The rte_mempool may be created by using a function rte_mempool_create( ). A process of creating the rte_mempool specifically includes:

(1) Calculate memory space that needs to be applied for the rte_mempool.

(2) Take out memory with a proper size from system memory by using a function rte_config.mem_config->free_memseg[], and record the memory in the memory pool (rte_config.mem_config->memzone[]).

(3) Initialize the newly created rte_mempool, and invoke a function rte_pktmbuf_pool_init( ) to initialize a private data structure of the rte_mempool.

(4) Invoke a function mempool_populate( ) and a function rte_pktmbuf_init( ) to initialize each mbuf of the rte_mempool.

It should be understood that the applied rte_mempool may include: a headmost memory pool data structure (struct rte_mempool), the private data structure (rte_pktmbuf_pool_private), and an allocated memory block (mbuf). The rte_pktmbuf_pool_private may also be referred to as a head of the memory pool.

Application software based on a DPDK or a user mode virtual switch accesses network packet content stored in the data by holding the head of the mbuf.

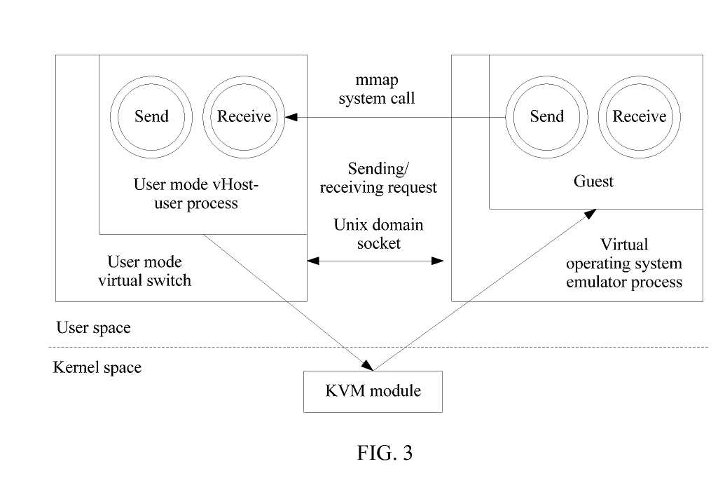

FIG. 3 shows a schematic block diagram of a packet forwarding apparatus in the prior art.

As shown in FIG. 3, a user mode virtual host management system (vHost-user) solution mainly includes three parts: a user mode vHost-user process, a vHost-user module of a QEMU process, and a front-end driver (virtio-net) of a guest operating system (Guest OS). The user mode vHost-user process is configured to receive a packet from a network interface card of the Guest OS or send a packet to a network interface card of the Guest OS. The vHost-user module of the QEMU process is configured to establish a message channel between the Guest OS and the user mode vHost-user process. The virtio-net network interface card of the Guest OS is configured to provide a uniform user mode network communications interface, so that a user may receive and send a packet through the interface.

If the Guest OS uses a kernel mode driver, a notification part of a multi-computer switcher (KVM) module of a kernel needs to be further included. If the Guest OS uses a user mode poll mode driver (Poll Mode Driver, PMD), the notification part is not needed.

A basic process of initializing the apparatus includes:

(1) Start the user mode vHost-user process, initialize a socket (socket) of a server, and monitor a QEMU socket event of a client.

(2) Start the QEMU process, connect to the user mode vHost-user process, and deliver Guest OS memory information to the user mode vHost-user process by using a memory mapping (mmap). The user mode vHost-user process maps the received memory information to address space of the user mode vHost-user process by using the memory mapping, and obtains read/write permission of Guest OS memory, so that the user mode vHost-user process can be authorized to access the Guest OS memory information.

A mmap system call may map all or some content of a disk file to user space, and a file read/write operation performed by a process becomes a memory read/write operation, so that a more useful dynamic memory allocation function is implemented.

(3) Start the Guest OS, load a virtio-net network interface card driver, deliver virtio-net network interface card receive/send queue information to the user mode vHost-user process, and negotiate a network interface card feature with the user mode vHost-user process. After receiving the virtio-net network interface card receive/send queue information, the user mode vHost-user process converts the virtio-net network interface card receive/send queue information into an address of the user mode vHost-user process, so as to access and operate a virtio-net network interface card receive/send queue.

In a VM packet receiving process, during initialization of the virtio-net network interface card, memory may be filled in a virtio-net network interface card receive queue (for example, a vring queue). The user mode vHost-user process receives a packet from a physical network interface card or a virtual network interface card, stores the packet in allocated memory, then obtains an available memory address of the virtio-net network interface card receive queue, and copy the packet to the virtio-net network interface card receive queue.

In a VM packet sending process, after generating a packet, a user mode process of the Guest OS fills the packet into a send queue (for example, a vring queue) by using a sending interface of the virtio-net network interface card. When polling a new packet in the send queue, the user mode vHost-user process allocates memory, copies the new packet in the send queue to memory of the user mode vHost-user process, processes the packet, and sends the packet to the physical network interface card or a virtual port.

Because a VM does not have permission to access host memory in a virtualization environment, the host may access memory in a vring queue of a virtio network interface card of the VM. However, the host memory is used as a buffer for the physical network interface card to receive a network packet outside the host.

Therefore, after the network packet is switched by using a Vswtich, the host needs to copy content of the network packet to the memory of the vring of the VM, so that the VM can process the network packet. Because the packet content of the network packet needs to be copied before the network packet enters the virtual machine, a central processing unit (Central Processing Unit, CPU) of the host is consumed heavily, thereby significantly affecting forwarding performance of the Vswtich.

Therefore, by using an Ivshmem mechanism of the QEMU, a DPDK program provides a quick (Host to guest and guest to Host) zero data copy shared solution for the virtual machine. Specifically, in an Ivshmem solution, one or more physical huge pages are mapped to an Ivshmem device by configuring a QEMU command. The Ivshmem device is mapped to the virtual machine by the QEMU as a PCI storage device. The Ivshmem may enable the host and all the VMs to share a same memory storage area. Because the VM and the VM on the host share memory, an mbufpool may be established in the shared memory area, and both the VM and the physical network interface card of the host may use an mbuf of the shared memory area to receive and transmit a packet. Because the mbuf exists in the shared memory area, the host may directly transmit a network packet received by the physical network interface card to the VM, without copying content of the network packet. Similarly, the Vswtich may directly forward a network packet sent by one VM to another VM, without copying content of the packet.

In the Ivshmem solution, when the network packet is received from the physical network interface card and gets in and out of the VM, it is unnecessary to copy the packet content. Therefore, CPU consumption can be greatly reduced, and forwarding performance of the vSwitch is improved.

However, because the host can share the memory to all the VMs, the host and all the VMs can read and write the shared memory area, and mbuf information established in the shared memory can be rewritten by all the virtual machines. This may cause a disastrous consequence for a system. Consequently, system reliability is reduced.

For example, a VM program exception causes pointer information of a head in the shared memory area to be rewritten, for example, m->pkt.data is rewritten to NULL. When the host or another VM accesses the pointer, a program exception occurs on the host or the VM.

For another example, when a VM processes a network packet stored in a data area, another VM rewrites length information of an IP header due to a program exception, and if the VM uses abnormal IP length information, an unpredictable exception is caused, and consequently, the VM is unavailable.

These problems that a single VM program exception causes the host and the another VM to be abnormal are unacceptable in a commercial field. This reduces system reliability.

The embodiments of the present disclosure provide a high-performance and high-reliability method for transmitting a network packet between a virtual machine and a host, and a physical host, so as to improve system reliability.

Optionally, the physical host includes at least two virtual machines, each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines.

The physical host separately establishes shared memory areas with the at least two virtual machines, and prohibits another virtual machine from accessing the shared memory area. This eliminates a possibility that a network packet stored in the shared memory area is modified by the another virtual machine, so that system reliability can be improved.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

Optionally, the memory block in the first memory pool includes a first memory segment and a second memory segment, the first memory segment is in front of the second memory segment, the first memory segment is configured to store address information of the second memory segment, and the second memory segment is configured to store a packet; and the physical host has at least two second memory pools, each second memory pool in the at least two second memory pools is in a one-to-one correspondence with each first memory pool, and each second memory pool has a first memory segment in a corresponding first memory pool. Optionally, the address information includes information about a data length field (data_len) and information about a data starting position offset field (data_off).

Specifically, the index (index) field may be added to a data structure of the memory block to identify the virtual machine to which the memory block belongs. Optionally, in an initialization phase of the memory block in the second memory pool, reassignment is performed on the memory block, so that memory blocks that have a same index and that are in the second memory pool and the first memory pool have a same data structure, that is, each second memory pool has a first memory segment in the corresponding first memory pool.

The memory block in the second memory pool includes only a head of the memory block. Therefore, the virtual machine uses a head in the shared memory area to operate the memory block, and the physical host uses the head in the second memory pool to operate the memory block. This resolves a problem that a system exception occurs on the physical host when the physical host operates the memory block because the virtual machine modifies the head of the memory block, so that system reliability is further improved.

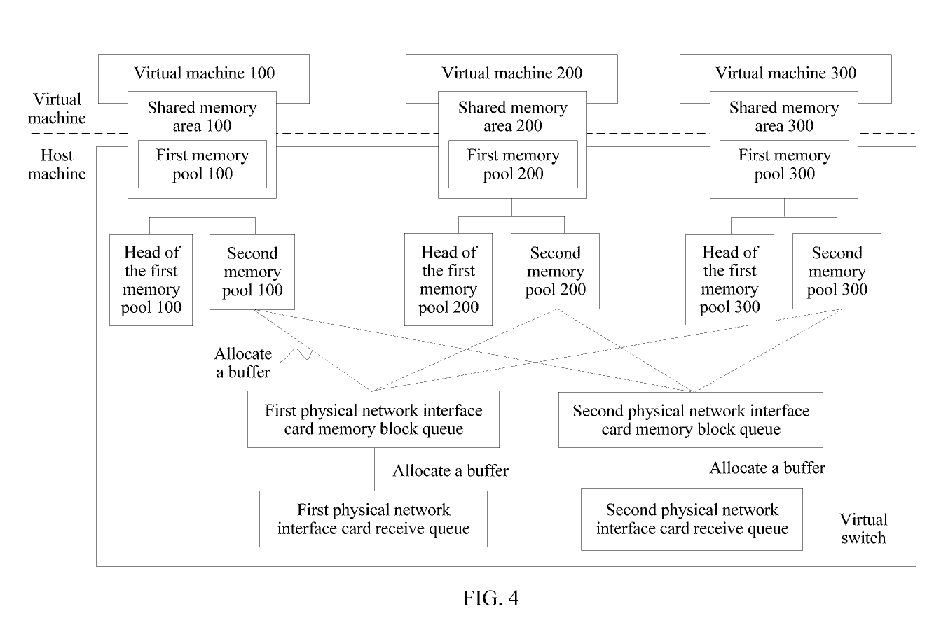

FIG. 4 is a schematic block diagram of an internal structure of a physical host for forwarding a packet according to an embodiment of the present disclosure.

As shown in FIG. 4, the physical host separately establishes a shared memory area 100, a shared memory area 200, and a shared memory area 300 that can be jointly accessed with a virtual machine (VM) 100, a virtual machine 200, and a virtual machine 300. The shared memory area 100 is prohibited from being accessed by another virtual machine different from the virtual machine 100 in the physical host, the shared memory area 200 is prohibited from being accessed by another virtual machine different from the virtual machine 200 in the physical host, and the shared memory area 300 is prohibited from being accessed by another virtual machine different from the virtual machine 300 in the physical host. A first memory pool (mempool) of an mbuf that is used by a physical network interface card to receive a packet is established in each shared memory area. Each first memory pool includes at least one memory block. The physical host establishes a second memory pool 100, a second memory pool 200, and a second memory pool 300 in a physical memory. The physical host establishes a first physical network interface card memory block queue and a second physical network interface card memory block queue in the physical host according to the second memory pool 100, the second memory pool 200, and the second memory pool 300. In addition, each physical network interface card memory block queue is corresponding to a physical network interface card receive queue (rx queue), and the physical network interface card receive queue invokes a memory block from the corresponding physical network interface card memory block queue.

In this embodiment of the present disclosure, the first memory pool may also be referred to as a vm mempool, and correspondingly, a head of the first memory pool may be referred to as a vm mempool head. The second memory pool may also be referred to as a host-vm mempool, a head of the second memory pool may also be referred to as a host-vm mempool head, and the memory block may also be referred to as an mbuf. This is not specifically limited in this embodiment of the present disclosure.

It should be understood that FIG. 4 describes an example of the internal structure of the physical host according to this embodiment of the present disclosure. This embodiment of the present disclosure imposes no limitation.

For example, the physical host may have one or more physical network interface card memory block queues, and one or more physical network interface card receive queues.

For another example, the physical host includes one or more virtual machines.

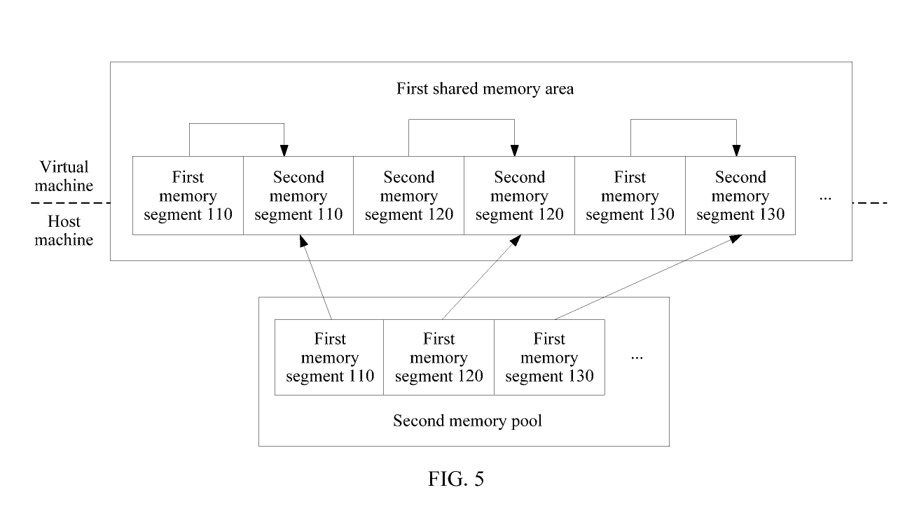

FIG. 5 is a schematic structural block diagram of a second memory pool corresponding to a first shared memory area according to an embodiment of the present disclosure.

As shown in FIG. 5, a first virtual machine running on a physical host has a first shared memory area, a memory pool in the first shared memory area has a first memory block 110, a first memory block 120, and a first memory block 130, and each memory block includes a first memory segment and a second memory segment. The physical host has the second memory pool, and the second memory pool has a first memory segment of each memory block. First memory segments that have a same index and that are in the second memory pool and the first memory pool are corresponding to a same second memory segment. For example, a first memory segment 110 in the first memory pool and a first memory segment 110 in the second memory pool are corresponding to a second memory segment 110. In this embodiment of the present disclosure, a memory block in the second memory pool is prohibited from being accessed by a virtual machine on the physical host, and a memory block in the first memory pool may be accessed by the physical host and the first virtual machine.

It should be understood that FIG. 5 describes an example of the first memory pool of the first virtual machine and the second memory pool on the corresponding physical host. This embodiment of the present disclosure imposes no limitation.

For example, another virtual machine on the physical host may further have a second memory pool.

Optionally, the physical host may fill a physical network interface card memory block queue according to memory blocks in the at least two second memory pools. The physical network interface card memory block queue is used as a queue from which a corresponding physical network interface card receive queue invokes a memory block.

Specifically, when receiving a packet, the physical network interface card memory receive queue stores the packet in a memory block in the physical network interface card receive queue, and directly invokes a memory block from the corresponding physical network interface card memory block queue to fill an empty location of the physical network interface card receive queue.

Optionally, the physical host obtains traffic statistics information of each virtual machine in the at least two virtual machines; determines, according to the traffic statistics information, a traffic ratio between traffic of each virtual machine in the at least two virtual machines and total traffic of the at least two virtual machines; and determines a traffic ratio of the first virtual machine as a ratio between a quantity of memory blocks corresponding to the first virtual machine filled in the physical network interface card memory block queue and a total quantity of memory blocks filled in the physical network interface card memory block queue.

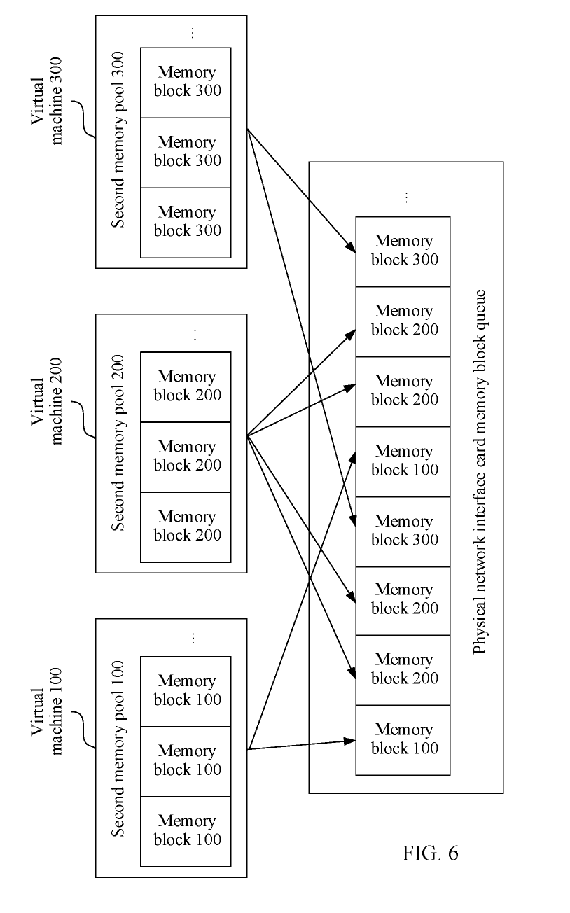

FIG. 6 is a schematic structural diagram of a physical network interface card memory block queue according to an embodiment of the present disclosure.

As shown in FIG. 6, a memory of a physical host has a second memory pool 100 corresponding to a virtual machine 100, a second memory pool 200 corresponding to a virtual machine 200, and a second memory pool 300 corresponding to a virtual machine 300. The second memory pool 100 has at least one memory block 100, the second memory pool 200 has at least one memory block 200, and the second memory pool 300 has at least one memory block 300. The physical host determines a memory block in the physical network interface card memory block queue according to the at least one memory block 100, the at least one memory block 200, and the at least one memory block 300.

Specifically, as shown in FIG. 6, by means of statistics, the physical host determines that: Traffic of the virtual machine 100: Traffic of the virtual machine 200: Traffic of the virtual machine 300=0.25:0.5:0.25. Therefore, when the physical host determines to fill the physical network interface card memory block queue, Memory block 100: Memory block 200: Memory block 300=0.25:0.5:0.25, and memory blocks are extracted from the second memory pool 100, the second memory pool 200, and the third memory pool 300 according to the foregoing ratio and a capacity of the physical network interface card memory block queue.

It should be understood that FIG. 6 describes an example that the physical network interface card memory block queue extracts the memory blocks from the second memory pool 100, the second memory pool 200, and the third memory pool 300. This embodiment of the present disclosure imposes no limitation.

Optionally, according to the traffic ratio between the at least two virtual machines, the physical host may further apply for a corresponding quantity of memory blocks from each second memory pool, and put the memory blocks into the physical network interface card memory block queue.

Specifically, the physical host obtains data packet traffic that is received by each virtual machine from a physical network interface card and that is collected periodically, and by using a statistical result, calculates a traffic proportion of each virtual machine or a traffic ratio between the traffic of each virtual machine and total traffic of the at least two virtual machines.

Therefore, according to the physical network interface card memory block queue in this embodiment of the present disclosure, network traffic that enters each virtual machine is monitored, and the ratio between memory blocks that are from the second memory pools and in the physical network interface card memory block queue is dynamically adjusted, so as to resolve a problem of a low matching probability between a memory block that stores a packet and a memory block of a destination virtual machine.

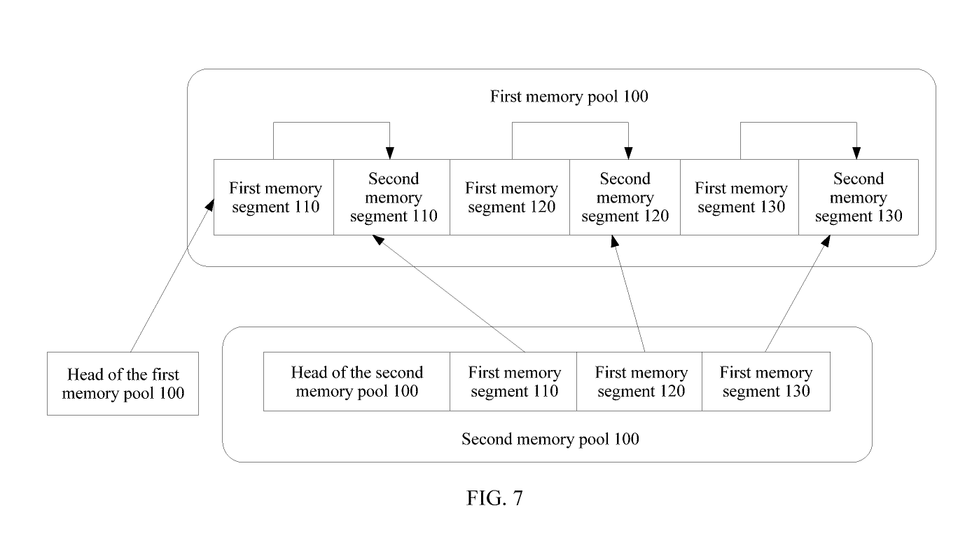

The foregoing describes, with reference to FIG. 1 to FIG. 6, a framework and a configuration of a virtual machine running on the physical host in the embodiments of the present disclosure. The following describes, in detail with reference to FIG. 7, a specific implementation in which the physical host establishes a shared memory area for each virtual machine.

Optionally, the physical host generates the first shared memory area by configuring a metadata file for the first virtual machine, and the metadata file includes port information of the first virtual machine and the memory block in the first memory pool of the first virtual machine.

Specifically, the physical host applies for four segments of memory zones (memzone) for each virtual machine, and one segment of memory zone is configured to store virtual port information (vport info). Each virtual machine on the physical host may be corresponding to one virtual port, and the other three segments of memzones are respectively configured to store a head of the first memory pool, the memory block of the first memory pool, and the second memory pool. The head of the first memory pool is configured to store control management information of the first memory pool.

Optionally, a memzone that needs to be shared is added to the metadata (metadata) file and shared with the specified virtual machine by using a QEMU program.

For example, when creating a virtual port for the first virtual machine, the physical host adds the memzone that is configured to store the memory block of the first memory pool of the first virtual machine and the memzone that is configured to store vport info of the first virtual machine to the metadata file.

Only the memzone that is configured to store the vport info of the first virtual machine is added to the metadata file, and a memzone that is configured to store other vport info is not added to the metadata file. This can effectively prevent the virtual port from damaging important information of another virtual port.

In addition, only the memzone that is configured to store the memory block of the first memory pool of the first virtual machine is added to the metadata file, and the memzone that is configured to store the head of the first memory pool of the first virtual machine is not added to the metadata file. This can prevent head management information of the first memory pool from being damaged by a virtual machine, so as to further improve system reliability.

FIG. 7 is a schematic structural block diagram of a shared memory area and a second memory pool according to an embodiment of the present disclosure.

Specifically, as shown in FIG. 7, a first memory pool 100 of a virtual machine 100 includes one or more memory blocks, and each memory block includes a first memory segment and a second memory segment. A head and the memory block that are of the first memory pool 100 are separately stored. A physical host has a second memory pool 100 corresponding to the virtual machine 100. The second memory pool 100 includes only the first memory segment of the memory block in the first memory pool 100. When creating the shared memory area for the virtual machine 100, the physical host adds only a memzone that is configured to store the memory block of the first memory pool 100 and a memzone that is configured to store the head of the first memory pool 100 to a metadata file.

It should be understood that FIG. 7 describes an example of a method for establishing the shared memory area for a first virtual machine by the physical host. This embodiment of the present disclosure imposes no limitation.

For example, the physical host may further establish a shared memory area for another virtual machine by using the foregoing method.

Therefore, in this embodiment of the present disclosure, the physical host separately establishes the shared memory area for the virtual machine running on the physical host, and prohibits another virtual machine from accessing the shared memory area. This eliminates a possibility that a network packet stored in the shared memory area is modified by the another virtual machine, so that system reliability can be improved.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

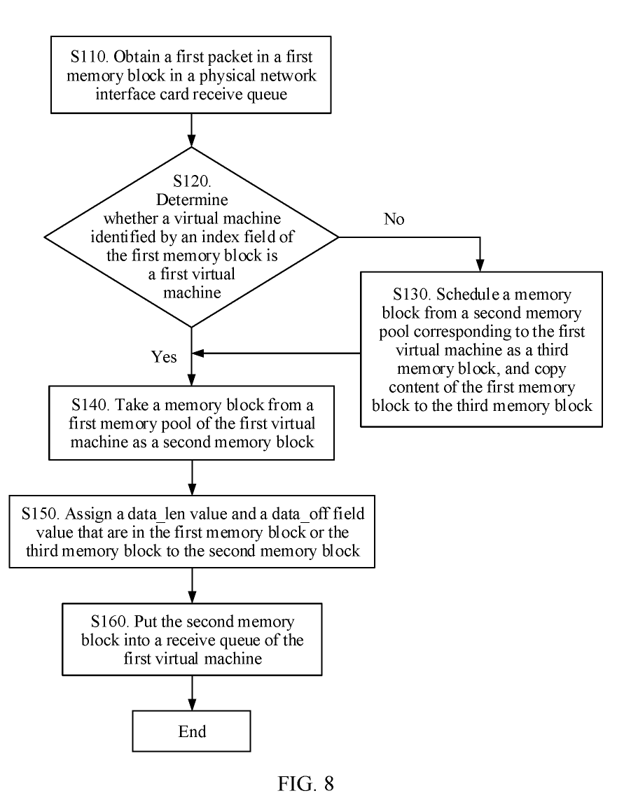

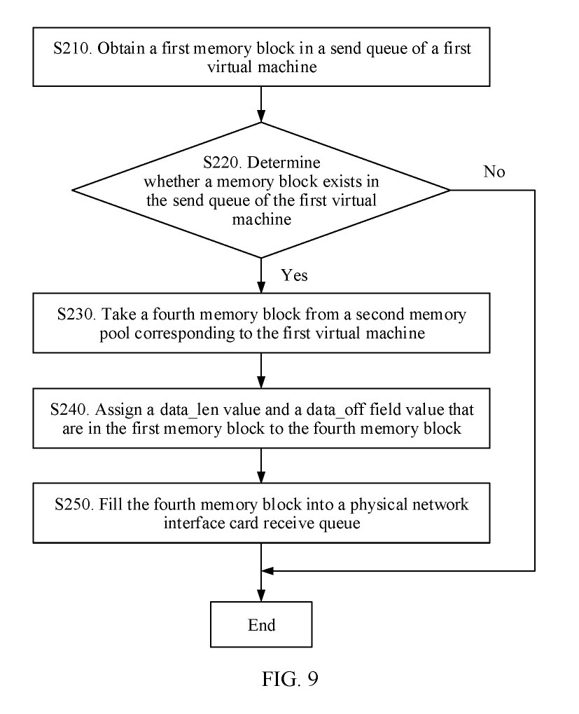

The following describes in detail a packet forwarding method based on the foregoing configured physical host and virtual machine with reference to FIG. 8 and FIG. 9.

A first virtual switch of at least one virtual switch configured on the physical host obtains a first memory block that stores a first packet, where the first memory block carries an index field that is used to identify a virtual machine to which the first memory block belongs; and the first virtual switch forwards the first packet according to the index field of the first memory block.

In this embodiment of the present disclosure, there are two cases in which the first virtual switch forwards the first packet: a case in which the first virtual switch forwards the first packet to a first virtual machine, and a case in which the first virtual switch forwards the first packet to a physical network interface card. Specifically, the first virtual switch obtains the first memory block in a physical network interface card receive queue, and forwards the first packet to the first virtual machine; or the first virtual switch obtains the first memory block in a send queue of the first virtual machine, and forwards the first packet to the physical network interface card receive queue.

Optionally, the first virtual switch is configured to forward the first packet to the first virtual machine.

Specifically, if a virtual machine identified by the index field of the first memory block is the first virtual machine, the first virtual switch schedules a memory block from the first memory pool of the first virtual machine as a second memory block; the first virtual switch assigns address information of the first memory block to the second memory block; and the first virtual switch fills the second memory block into a receive queue of the first virtual machine.

If a virtual machine identified by the index field of the first memory block is not the first virtual machine, the first virtual switch schedules a memory block from the at least two second memory pools as a third memory block, where a virtual machine identified by an index field of the third memory block is the first virtual machine; the first virtual switch copies content of the first memory block to the third memory block; the first virtual switch schedules a memory block from the first memory pool of the first virtual machine as the second memory block; the first virtual switch assigns address information of the third memory block to the second memory block; and the first virtual switch fills the second memory block into the receive queue of the first virtual machine.

FIG. 8 is a schematic flowchart of a method for forwarding a packet to a first virtual machine by a first virtual switch according to an embodiment of the present disclosure.

As shown in FIG. 8, a process in which the first virtual switch forwards the packet to the first virtual machine specifically includes:

S110. Obtain a first packet in a first memory block in a physical network interface card receive queue.

S120. Determine whether a virtual machine identified by an index field of the first memory block is a first virtual machine.

S130. If the virtual machine identified by the index field of the first memory block is not the first virtual machine, schedule a memory block from a second memory pool corresponding to the first virtual machine as a third memory block, and copy content of the first memory block to the third memory block.

S140. If the virtual machine identified by the index field of the first memory block is the first virtual machine, take a memory block from a first memory pool of the first virtual machine as a second memory block.

S150. Assign a data_len value and a data_off field value that are in the first memory block or the third memory block to the second memory block.

S160. Put the second memory block into a receive queue of the first virtual machine.

In this embodiment of the present disclosure, the memory block for forwarding the packet is extracted from the second memory pool, and a data area of the second memory pool is not shared and includes head information. This can effectively prevent the head information of the memory block from being damaged by the virtual machine in a packet forwarding process, so as to improve system reliability.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

Optionally, the first virtual switch is configured to forward the first packet to the physical network interface card receive queue.

Specifically, the first virtual switch obtains a fourth memory block from the at least two second memory pools, where a virtual machine identified by an index field of the fourth memory block is the first virtual machine; the first virtual switch assigns address information of the first memory block to the fourth memory block; and the first virtual switch fills the fourth memory block into the physical network interface card receive queue. The address information includes information about a data length field and information about a data starting position offset field.

FIG. 9 is a schematic flowchart of a method for forwarding a packet to a physical network interface card receive queue by a first virtual switch according to an embodiment of the present disclosure.

As shown in FIG. 9, a process in which the first virtual switch forwards the packet to the physical network interface card receive queue specifically includes:

S210. Obtain a first memory block in a send queue of a first virtual machine.

S220. Determine whether a memory block exists in the send queue of the first virtual machine.

S230. If a memory block exists in the send queue of the first virtual machine, take a fourth memory block from a second memory pool corresponding to the first virtual machine.

S240. Assign a data_len value and a data_off field value that are in the first memory block to the fourth memory block.

S250. Fill the fourth memory block into the physical network interface card receive queue.

In this embodiment of the present disclosure, the memory block for forwarding the packet is extracted from the second memory pool, and a data area of the second memory pool is not shared and includes head information. This can effectively prevent the head information of the memory block from being damaged by the virtual machine in a packet forwarding process, so as to improve system reliability.

In addition, a network packet stored in each shared memory area can be jointly accessed by a corresponding virtual machine and the physical host. This resolves a problem that packet content needs to be copied when the network packet is transmitted between the physical host and the virtual machine, thereby reducing CPU consumption and improving system forwarding performance.

The method disclosed in the foregoing embodiment of the present disclosure may be applied to a processor, or implemented by the processor. The processor may be an integrated circuit chip and has a signal processing capability. In an implementation process, the steps in the foregoing method may be implemented by using a hardware integrated logical circuit in the processor, or by using an instruction in a form of software.

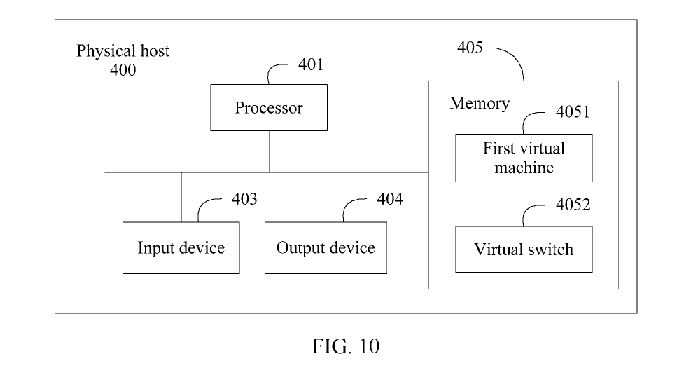

FIG. 10 is a schematic block diagram of a physical host 400 according to an embodiment of the present disclosure.

As shown in FIG. 10, the physical host provided in this embodiment of the present disclosure includes an input device 403 (optional), an output device 404 (optional), a processor 401, and a memory 405. In FIG. 10, the processor 401, the memory 405, and an interface communicate with each other and transmit a control and/or a data signal by using an internal connection channel.

The memory 405 may include a read-only memory and a random access memory, and provide an instruction and data for the processor 401. A part of the memory 405 may further include a nonvolatile random access memory (NVRAM). The memory 405 stores an executable module, a data structure, a subset of the executable module and the data structure, or an extended set of the executable module and the data structure, for example, an operation instruction, including various operation instructions used for implementing various operations; and for another example, an operating system, including various system programs used for implementing various basic services and processing a hardware-based task.

The processor 401 invokes the operation instruction stored in the memory 405 (the operation instruction may be stored in an operating system).

In this embodiment of the present disclosure, the processor 401 simulates, on the physical host 400, a first virtual switch 4052 and at least two virtual machines by invoking virtual machine software stored in the memory 405. Each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine 4051 in the at least two virtual machines is prohibited from being accessed by another virtual machine different from the first virtual machine 4051 in the at least two virtual machines; and the first virtual switch 4052 is configured to:
obtain a first memory block that stores a first packet, where the first memory block carries an index field that is used to identify a virtual machine to which the first memory block belongs; and forward the first packet according to the index field of the first memory block.

Optionally, the memory block in each first memory pool includes a first memory segment and a second memory segment, the first memory segment is in front of the second memory segment, the first memory segment is configured to store address information of the second memory segment, and the second memory segment is configured to store a packet; and the physical host 400 has at least two second memory pools, each second memory pool in the at least two second memory pools is in a one-to-one correspondence with each first memory pool, and each second memory pool has a first memory segment in a corresponding first memory pool.

The first virtual switch 4052 is specifically configured to forward the first packet according to the at least two second memory pools and the index field of the first memory block.

Optionally, the physical host 400 has a physical network interface card receive queue according to the at least two second memory pools, the first virtual machine 4051 has a send queue and/or a receive queue, and the receive queue or the send queue includes some or all memory blocks in a first memory pool of the first virtual machine 4051.

The first virtual switch 4052 is specifically configured to: obtain the first memory block in the physical network interface card receive queue, or obtain the first memory block in the send queue of the first virtual machine 4051.

Optionally, the first virtual switch 4052 is configured to forward a packet to the first virtual machine 4051.

Specifically, if a virtual machine identified by the index field of the first memory block is the first virtual machine 4051, the first virtual switch 4052 is specifically configured to:
schedule a memory block from the first memory pool of the first virtual machine 4051 as a second memory block; assign address information of the first memory block to the second memory block; and fill the second memory block into the receive queue of the first virtual machine 4051.

If a virtual machine identified by the index field of the first memory block is not the first virtual machine 4051, the first virtual switch 4052 is specifically configured to:
schedule a memory block from the at least two second memory pools as a third memory block, where a virtual machine identified by an index field of the third memory block is the first virtual machine 4051; copy content of the first memory block to the third memory block; schedule a memory block from the first memory pool of the first virtual machine 4051 as the second memory block; assign address information of the third memory block to the second memory block; and fill the second memory block into the receive queue of the first virtual machine 4051.

Optionally, the first virtual switch 4052 is configured to forward the first packet to the physical network interface card receive queue, where the first virtual switch 4052 is specifically configured to: obtain a fourth memory block from the at least two second memory pools, where a virtual machine identified by an index field of the fourth memory block is the first virtual machine 4051; assign address information of the first memory block to the fourth memory block; and fill the fourth memory block into the physical network interface card receive queue.

Optionally, the address information includes information about a data length field and information about a data starting position offset field.

Optionally, the physical host has a physical network interface card memory block queue, and the physical host is further configured to fill the physical network interface card memory block queue according to a memory block in the at least two second memory pools.

Optionally, before the physical host fills the physical network interface card memory block queue according to the memory block in the at least two second memory pools, the physical host is configured to: obtain traffic statistics information of each virtual machine in the at least two virtual machines; determine, according to the traffic statistics information, a traffic ratio between traffic of each virtual machine in the at least two virtual machines and total traffic of the at least two virtual machines; and determine a traffic ratio of the first virtual machine 4051 as a ratio between a quantity of memory blocks corresponding to the first virtual machine 4051 filled in the physical network interface card memory block queue and a total quantity of memory blocks filled in the physical network interface card memory block queue.

Optionally, the physical host is further configured to generate the first shared memory area by configuring a metadata file for the first virtual machine 4051, and the metadata file includes port information of the first virtual machine 4051 and the first memory pool of the first virtual machine 4051.

It should be understood that FIG. 10 merely describes an example of the block diagram of the physical host according to this embodiment of the present disclosure. This embodiment of the present disclosure imposes no limitation. For example, a plurality of virtual machines, a plurality of virtual switches, and the like run on the physical host.

In an implementation process, the foregoing software modules may be located in a mature storage medium in the art, such as a random access memory, a flash memory, a read-only memory, a programmable read-only memory, an electrically erasable programmable memory, or a register. The storage medium is located in a memory, and a processor executes an instruction in the memory and completes the steps in the foregoing methods in combination with hardware of the processor. To avoid repetition, details are not described herein.

The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the embodiments of the present disclosure.

It may be clearly understood by a person skilled in the art that, for the purpose of convenient and brief description, for a detailed working process of the foregoing system, physical host, and unit, reference may be made to a corresponding process in the foregoing method embodiments, and details are not described herein again.

In the several embodiments provided in the present disclosure, it should be understood that the disclosed system, physical host, and method may be implemented in other manners. For example, the described physical host embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the physical hosts or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the embodiments of the present disclosure essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps in the embodiments of the present disclosure. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of the embodiments of the present disclosure, but are not intended to limit the protection scope of the embodiments of the present disclosure. Any modification or replacement readily figured out by a person skilled in the art within the technical scope disclosed in the embodiments of the present disclosure shall fall within the protection scope of the embodiments of the present disclosure. Therefore, the protection scope of the embodiments of the present disclosure shall be subject to the protection scope of the claims.

What is claimed is:

1. A packet forwarding method, wherein the method is applied to a physical host, and the physical host comprises a first virtual switch and at least two virtual machines;
each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines; and
the method comprises:
obtaining, by the first virtual switch, a first memory block that stores a first packet, wherein the first memory block carries an index field that is used to identify a virtual machine to which the first memory block belongs; and
forwarding, by the first virtual switch, the first packet according to the index field of the first memory block.

2. The method according to claim 1, wherein
the memory block in each first memory pool comprises a first memory segment and a second memory segment, the first memory segment is in front of the second memory segment, the first memory segment is configured to store address information of the second memory segment, and the second memory segment is configured to store a packet;
the physical host has at least two second memory pools, each second memory pool in the at least two second memory pools is in a one-to-one correspondence with each first memory pool, and each second memory pool has a first memory segment in a corresponding first memory pool; and
the forwarding, by the first virtual switch, the first packet according to the index field of the first memory block comprises:
forwarding, by the first virtual switch, the first packet according to the at least two second memory pools and the index field of the first memory block.

3. The method according to claim 2, wherein the physical host has a physical network interface card receive queue according to the at least two second memory pools, the first virtual machine has a send queue and/or a receive queue, and the receive queue or the send queue of the first virtual machine comprises some or all memory blocks in a first memory pool of the first virtual machine; and
the obtaining, by the first virtual switch, a first memory block that stores a first packet comprises:
obtaining, by the first virtual switch, the first memory block in the physical network interface card receive queue; or
obtaining, by the first virtual switch, the first memory block in the send queue of the first virtual machine.

4. The method according to claim 3, wherein the first virtual switch is configured to forward a packet to the first virtual machine; and
the forwarding, by the first virtual switch, the first packet according to the at least two second memory pools and the index field of the first memory block comprises:
if a virtual machine identified by the index field of the first memory block is the first virtual machine, scheduling, by the first virtual switch, a memory block from the first memory pool of the first virtual machine as a second memory block;
assigning, by the first virtual switch, address information of the first memory block to the second memory block; and
filling, by the first virtual switch, the second memory block into the receive queue of the first virtual machine.

5. The method according to claim 3, wherein the first virtual switch is configured to forward a packet to the first virtual machine; and
the forwarding, by the first virtual switch, the first packet according to the at least two second memory pools and the index field of the first memory block comprises:
if a virtual machine identified by the index field of the first memory block is not the first virtual machine, scheduling, by the first virtual switch, a memory block from the at least two second memory pools as a third memory block, wherein a virtual machine identified by an index field of the third memory block is the first virtual machine;
copying, by the first virtual switch, content of the first memory block to the third memory block;
scheduling, by the first virtual switch, a memory block from the first memory pool of the first virtual machine as the second memory block;
assigning, by the first virtual switch, address information of the third memory block to the second memory block; and
filling, by the first virtual switch, the second memory block into the receive queue of the first virtual machine.

6. The method according to claim 3, wherein the first virtual switch is configured to forward the first packet to the physical network interface card receive queue; and
the forwarding, by the first virtual switch, the first packet according to the at least two second memory pools and the index field of the first memory block comprises:
obtaining, by the first virtual switch, a fourth memory block from the at least two second memory pools, wherein a virtual machine identified by an index field of the fourth memory block is the first virtual machine;
assigning, by the first virtual switch, address information of the first memory block to the fourth memory block; and
filling, by the first virtual switch, the fourth memory block into the physical network interface card receive queue.

7. The method according to claim 4, wherein the address information comprises information about a data length field and information about a data starting position offset field.

8. The method according to claim 2, wherein the physical host has a physical network interface card memory block queue, and the method further comprises:
filling, by the physical host, the physical network interface card memory block queue according to a memory block in the at least two second memory pools.

9. The method according to claim 8, wherein before the filling, by the physical host, the physical network interface card memory block queue according to a memory block in the at least two second memory pools, the method further comprises:
obtaining, by the physical host, traffic statistics information of each virtual machine in the at least two virtual machines; and
determining, by the physical host according to the traffic statistics information, a traffic ratio between traffic of each virtual machine in the at least two virtual machines and total traffic of the at least two virtual machines; and
the filling, by the physical host, the physical network interface card memory block queue according to a memory block in the at least two second memory pools comprises:
determining, by the physical host, a traffic ratio of the first virtual machine as a ratio between a quantity of memory blocks corresponding to the first virtual machine filled in the physical network interface card memory block queue and a total quantity of memory blocks filled in the physical network interface card memory block queue.

10. The method according to claim 1, wherein the physical host generates the first shared memory area by configuring a metadata file for the first virtual machine, and the metadata file comprises port information of the first virtual machine and the memory block in the first memory pool of the first virtual machine.

11. A physical host, wherein the physical host comprises a first virtual switch and at least two virtual machines;
each virtual machine in the at least two virtual machines has a shared memory area that can be jointly accessed by the physical host, each shared memory area has a first memory pool, each first memory pool has at least one memory block, a memory block in each first memory pool has an index field that is used to identify a virtual machine to which the memory block belongs, and a first shared memory area corresponding to a first virtual machine in the at least two virtual machines is prohibited from being accessed by another virtual machine different from the first virtual machine in the at least two virtual machines; and
the first virtual switch is configured to:
obtain a first memory block that stores a first packet, wherein the first memory block carries an index field that is used to identify a virtual machine to which the first memory block belongs; and
forward the first packet according to the index field of the first memory block.

12. The physical host according to claim 11, wherein
the memory block in each first memory pool comprises a first memory segment and a second memory segment, the first memory segment is in front of the second memory segment, the first memory segment is configured to store address information of the second memory segment, and the second memory segment is configured to store a packet;
the physical host has at least two second memory pools, each second memory pool in the at least two second memory pools is in a one-to-one correspondence with each first memory pool, and each second memory pool has a first memory segment in a corresponding first memory pool; and
the first virtual switch is specifically configured to forward the first packet according to the at least two second memory pools and the index field of the first memory block.

13. The physical host according to claim 12, wherein the physical host has a physical network interface card receive queue according to the at least two second memory pools, the first virtual machine has a send queue and/or a receive queue, and the receive queue or the send queue of the first virtual machine comprises some or all memory blocks in a first memory pool of the first virtual machine; and
the first virtual switch is specifically configured to: obtain the first memory block in the physical network interface card receive queue; or
obtain the first memory block in the send queue of the first virtual machine.

14. The physical host according to claim 13, wherein the first virtual switch is configured to forward a packet to the first virtual machine;
if a virtual machine identified by the index field of the first memory block is the first virtual machine, the first virtual switch schedules a memory block from the first memory pool of the first virtual machine as a second memory block; and
the first virtual switch is configured to:
assign address information of the first memory block to the second memory block; and
fill the second memory block into the receive queue of the first virtual machine.

15. The physical host according to claim 13, wherein the first virtual switch is configured to forward a packet to the first virtual machine;
if a virtual machine identified by the index field of the first memory block is not the first virtual machine, the first virtual switch schedules a memory block from the at least two second memory pools as a third memory block, wherein a virtual machine identified by an index field of the third memory block is the first virtual machine; and
the first virtual switch is configured to:
copy content of the first memory block to the third memory block;
schedule a memory block from the first memory pool of the first virtual machine as the second memory block;
assign address information of the third memory block to the second memory block; and
fill the second memory block into the receive queue of the first virtual machine.

16. The physical host according to claim 13, wherein the first virtual switch is configured to forward the first packet to the physical network interface card receive queue;
the first virtual switch is configured to obtain a fourth memory block from the at least two second memory pools, wherein a virtual machine identified by an index field of the fourth memory block is the first virtual machine; and
the first virtual switch is configured to:
assign address information of the first memory block to the fourth memory block; and
fill the fourth memory block into the physical network interface card receive queue.

17. The physical host according to claim 14, wherein the address information comprises information about a data length field and information about a data starting position offset field.

18. The physical host according to claim 12, wherein the physical host has a physical network interface card memory block queue, and the physical host is further configured to fill the physical network interface card memory block queue according to a memory block in the at least two second memory pools.

19. The physical host according to claim 18, wherein before the physical host fills the physical network interface card memory block queue according to the memory block in the at least two second memory pools,
the physical host is configured to:
obtain traffic statistics information of each virtual machine in the at least two virtual machines;
determine, according to the traffic statistics information, a traffic ratio between traffic of each virtual machine in the at least two virtual machines and total traffic of the at least two virtual machines; and
determine a traffic ratio of the first virtual machine as a ratio between a quantity of memory blocks corresponding to the first virtual machine filled in the physical network interface card memory block queue and a total quantity of memory blocks filled in the physical network interface card memory block queue.

20. The physical host according to claim 11, wherein the physical host is further configured to generate the first shared memory area by configuring a metadata file for the first virtual machine, and the metadata file comprises port information of the first virtual machine and the memory block in the first memory pool of the first virtual machine.
